(19) United States
(12) Patent Application Publication
(10) Pub. No.: US 2026/0113256 A1
(43) Pub. Date: Apr. 23, 2026

(54) NETWORK SERVICE AND IOT CONNECTIVITY DETECTION IN OVERLAY FABRICS

(71) Applicant: Cisco Technology, Inc., San Jose, CA (US)

(72) Inventors: Balaji Sundararajan, Fremont, CA (US); Arul Murugan Manickam, Mountain House, CA (US); Sourav Sen, San Jose, CA (US); Srilatha Tangirala, San Jose, CA (US); Ajeet Pal Singh Gill, Fremont, CA (US); Nithin Bangalore Raju, San Jose, CA (US); Pradeep Varma Konduru, San Jose, CA (US)

(21) Appl. No.: 18/921,370

(22) Filed: Oct. 21, 2024

(51) Int. Cl. H04L 43/0811; H04L 12/46; H04L 41/0654; H04L 43/12

(52) U.S. Cl. CPC H04L 43/0811; H04L 12/4641; H04L 41/0654; H04L 43/12

(57) ABSTRACT

Techniques for detecting network service and Internet of Things (IoT) device reachability via inline monitoring with in-band probes in an SD-WAN overlay fabric are described. The techniques may include enabling, by a multi-tenant edge device at a branch site, a tenant onboard the multi-tenant edge device, to transmit a probe to a network service at a first data center. The multi-tenant edge device may determine, based at least in part on the probe, whether the network service is reachable. Based at least in part on determining that the network service is not reachable, the multi-tenant.

### TECHNICAL FIELD

The present disclosure relates generally to detecting network service and Internet of Things (IoT) device reachability via inline monitoring with in-band probes in an SD-WAN overlay fabric.

### BACKGROUND

Today's networking evolution is moving to Software Defined Wide Area Networks (SD-WAN), a virtual WAN architecture that allows enterprise organizations to leverage any combination of transport services (including MPLS, LTE, broadband internet service, etc.) to securely connect users, applications, and data across multiple locations while providing improved performance, reliability, and scalability, while at the same time providing centralized control and visibility over the entire network. SD-WANs functions by creating a network of SD-WAN devices connected by encrypted tunnel. Typically, an SD-WAN service provider that provides connection services for enterprise organizations, or tenants, provides each tenant with its own dedicated SD-WAN edge device (e.g., edge router) to connect to the SD-WAN overlay. The dedicated edge device for the tenant is onboarded to the network, and its connections configured for the tenant.

Additionally, in an SD-WAN deployment, a centralized controller is typically responsible for orchestrating the control plane, managing routing decisions, managing devices, and ensuring secure communication between WAN edges. The controller provides a central point of network management through which network decisions are made. Typically, in an SD-WAN the controller is responsible for monitoring and rerouting traffic when network service reachability is less than optimal. This may be accomplished using dedicated probes sent for monitoring network service availability on a per service basis at a datacenter, and this information is relayed via a routing protocol from the controller. Similarly, the controller also detects internet of things (IoT) endpoint device failures in a network and can initiate remedial action when an IoT device is offline.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an example environment that may implement various aspects of the technologies directed to detecting network service and IoT endpoint device reachability via inline monitoring with in-band probes in an SD-WAN overlay fabric.

FIG. 2 illustrates an example of an inline data packet that may be utilized for relaying network service and IoT endpoint device reachability.

FIG. 3 illustrates an example hub and spoke model that may implement techniques for detecting network service reachability.

FIG. 4 illustrates an example environment that may implement various aspects of the technologies directed to detecting network service and IoT endpoint device reachability via inline monitoring with in-band probes in an SD-WAN overlay fabric.

FIG. 5 is a flow diagram illustrating an example method associated with the techniques described herein for detecting network service reachability via inline monitoring with in-band probes in an SD-WAN overlay fabric.

FIG. 6 is a flow diagram illustrating an example method associated with the techniques described herein for detecting IoT endpoint device reachability via inline monitoring with in-band probes in an SD-WAN overlay fabric.

FIG. 7 illustrates a block diagram illustrating an example packet switching system that can be utilized to implement various aspects of the technologies disclosed herein.

FIG. 8 illustrates a block diagram illustrating certain components of an example node that can be utilized to implement various aspects of the technologies disclosed herein.

FIG. 9 is a computer architecture diagram showing an illustrative computer hardware architecture for implementing a server device that can be utilized to implement aspects of the various technologies presented herein.

### DESCRIPTION OF EXAMPLE EMBODIMENTS

### Overview

This disclosure describes a method, for detecting network service reachability in a software defined wide area network (SD-WAN) overlay fabric. The method includes enabling, by a multi-tenant device at a branch site, a tenant onboard the multi-tenant edge device, to transmit a probe to a network service located at a first data center. In addition, the method includes determining, by the multi-tenant edge device and based at least in part on the probe, whether the network service is reachable. Finally, based at least in part on determining that the network service is not reachable, the method includes switching, by the multi-tenant edge device, network traffic to a second data center where the network service is reachable.

This disclosure also describes another method, for detecting internet of things (IoT) device reachability. The method includes determining, by a network edge device, that an IoT device is not reachable, and transmitting, by the network edge device and to a head end network device, a data packet, the data packet including information indicating that the IoT device is not reachable such that action can be taken to remediate IoT device reachability.

Additionally, the techniques described herein may be performed by a system and/or device having non-transitory computer-readable media storing computer-executable instructions that, when executed by one or more processors, performs the method described above.

### EXAMPLE EMBODIMENTS

As described above, a Software Defined Wide Area Network (SD-WAN) allows enterprise organizations to securely connect users, applications, and data across multiple locations while providing improved performance, reliability, and scalability, while at the same time providing centralized control and visibility over the entire network. Typically, an SD-WAN controller provides a central point of network management through which network decisions are made. Among other functions, the SD-WAN controller is responsible for monitoring and rerouting traffic when network service reachability is less than optimal. Additionally, the controller also detects Internet of Things (IoT) endpoint device failures in a network and can initiate remedial action when an IoT device is offline. However, since routing decisions and failure remediation go through a centralized controller, the time taken to monitor and withdraw data traffic can lead to considerable outage until network reconvergence. Outage time can be in the order of minutes, which can be catastrophic for end users or critical for an IoT network. Additionally, it is not possible to advertise the availability of network services to the edge in headless mode.

Conventionally when a firewall, load balancer, caching infrastructure, or the like, hosted in a colocation sight, datacenter, cloud, etc. are leveraged in the path of network traffic, a multi-tenant router hosted in the cloud may monitor traffic on a per tenant basis, and these per tenant probes are relayed via a network controller. This situation can lead to a significant delay at the edge to withdraw routes in case an outage is detected at the network headend. Additionally, IoT devices like cameras, sensors, etc. hosted in frictionless stores may be connected via Zigbee, Council of Oracle Protocol (CooP) protocols and the like, towards the LAN infrastructure. Detecting non-availability of these IoT endpoints in headless mode is not possible. Therefore, there is a need for techniques to reduce the time it takes for network reconvergence when a network service is unreachable or an IoT endpoint device fails, especially when running in headless mode.

This disclosure describes enhancing application aware routing using techniques for network service and IoT connectivity detection in overlay fabrics, by mapping Type Length Values (TLVs) to different network services to enable smart identification, quicker detection of service reachability, and improved resilience in headless mode. Similarly, a TLV may be mapped to an individual IoT device to enable smart identification, determined that an IoT device is offline, and initiate remedial action. To implement techniques described herein, in some examples, a multi-tenant edge device located at a branch site may enable a tenant onboard a multi-tenant edge device to transmit probes to a network service located at a datacenter. Based on the probes, the multi-tenant edge device may determine whether the network service is reachable. If the network service is determined to be unreachable, the multi-tenant edge device may switch network traffic to a second data center where the network service is reachable. In another example, IoT device reachability may be detected. A network edge device may determine that an IoT device is not reachable, and transmit, to a head end network device, a data packet that includes information indicating that the particular IoT device is not reachable (by embedding a TLV associated with the particular IoT device) such that action can be taken to remediate IoT device reachability. By using inline monitoring, detection and remediation of unreachable network services and IoT devices is significantly faster than conventional means via a network controller.

The techniques described herein utilize enhanced application aware probing techniques for detecting network services and IoT endpoint device reachability via inline monitoring with in-band probes in an SD-WAN overlay fabric. The technique described herein provide multiple improvements over conventional solutions. Using inline data for measurements such as per queue level accurate measurements, faster detection in the order of second (e.g., 10 to 60 seconds) is provided for. Additionally, when using enhanced application aware routing, immediate action may be taken to switch to a better path if a network services is not reachable for a tenant. Further, multiple tenants are allowed to independently probe for network service reachability, with probe results being multiplexed on a same Bidirectional Forwarding Detection (BFD) channel towards the edge for efficient traffic switching by a multi-tenant HUB router. In addition, enhanced application aware routing provides for configuring controller failure in headless mode and efficiently handling probes to quickly obtain network reachability information for faster convergence on the edge network to seamlessly switch to backup data centers.

Furthermore, with enhanced application aware routing in a LAN configured with IoT endpoint devices, a LAN switch can detect that a particular IoT endpoint device is not reachable, when that IoT device fails via the Application Programming Interface (API). In this situation, the in-band mechanism allows for the forwarding of information (via embedded TLV associated with the particular failed IoT device) to the head end routers for corrective action to be taken on the IoT endpoint device, ensuring that failures are addressed promptly, even in cases where network controllers may detect issues at a slower rate. Thus, the techniques described herein enable the detection of IoT device failure, even in headless mode, and faster than conventional methods that required detection via a network controller. The techniques described herein further enable the ability to transport different types of segments on the wire to clearly indicate which entity in the LAN sent the data as well as differentiated probing for multiple tenants onboard a multi-tenant edge device. The techniques described here also provide for the ability to monitor network services on the datacenter on a per tenant basis using enhanced application aware probing.

Thus, the techniques described here enable customers to have protected network monitoring on a per tenant basis with potentially varied monitoring times, and detect near instantly, any network services that are unreachable or IoT devices going offline on the LAN. Because these techniques do not require network reachability and IoT endpoint device failure information to be relayed via the network controller, but instead are relayed in-band, traffic outage time is significantly reduced, which in turn greatly improves network security and quality of service. In fact, outage time may be reduced from the order of several minutes down to seconds. Additionally, in the case where a controller is offline, network monitoring may still be ensured, as the information regarding network service reachability and IoT endpoint device reachability is relayed inline, and does not necessitate the network controller.

In some implementations, a multi-tenant HUB router may host several tenants onboard and each tenant may probe for network service reachability independently. For example, a firewall at a headend router may be shared by the tenants onboard the multi-tenant HUB router. In some examples, each tenant may independently probe, and the probe results may be multiplexed on the same BFD channel towards the edge. This will allow each tenant onboard the multi-tenant HUB router to probe at different intervals, should some tenants desire to probe more or less frequently than others. In other instances, one or more of the tenant may share a probe as the probes are probing for reachability of a shared network resource, in this example, a shared firewall. This will enable edge routers to switch traffic to other HUB sites, or multi-tenant routers at the HUB, when health probes indicate that the network service is experiencing reachability issues by relaying the service un-availability in-band via BFD probes. The edge router may then switch data traffic to a different available HUB site with the network service, thus, avoiding blackholing the data traffic.

In some examples, on a LAN at a branch site, multiple IoT endpoint devices may be connected to a LAN switch. The LAN switch may detect, via Zigbee, CooP, or other appropriate IoT protocol, that a particular IoT endpoint device is not reachable. This information may be forwarded, in-band and via an embedded TLV in a data packet, to a head end router, so that corrective action can be undertaken for the IoT endpoint device. This will enable faster IoT endpoint device failure detection and remediation, even if the failure is eventually detected by a network controller.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

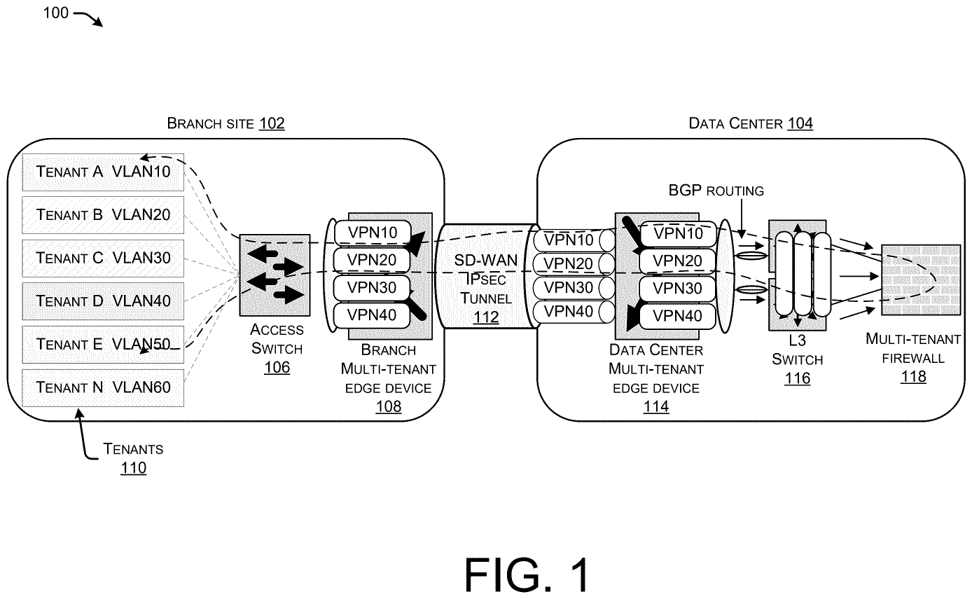

FIG. 1 illustrates an example environment 100 that may implement various aspects of the technologies directed to detecting network service and IoT endpoint device reachability via inline monitoring with in-band probes in an SD-WAN overlay fabric. Environment 100 includes a branch site 102. The branch site may represent a branch office, retail store, or any remote site of an enterprise organization having multiple locations. FIG. 1 also include a data center 104. The data center may be a location of an enterprise organization that contains large scale computing infrastructure such as servers, data storage, network devices such as HUBs, routers, switches, gateways, firewalls, etc.

Branch site 102 is illustrated as including networking devices such as access switch 106 and multi-tenant edge device 108 (e.g., a multi-tenant router). However, this is by example and not limitation, branch site 102 may contain any number and type of networking infrastructure. Branch site 102 also includes multiple tenants 110, specifically, tenant A, tenant B, tenant C, tenant D, tenant E, and tenant N. Again, the multiple tenant shown are an example of multiple tenant, and the technique described here may be leveraged when more or less tenants are present at a branch site. As an example, branch site 102 may be retail space where the tenants 110 are multiple different vendors that share the retail space. In another example, the branch site 102 may be a largescale sporting venue, and the tenant 110 may represent multiple different restaurants, store selling memorabilia and souvenirs, and the like. However, these are examples and not meant to by limiting, as the tenants 110 may represent any tenant connected to a network.

Typically, in conventional systems, an SD-WAN service provider that provides connection services for enterprise organizations, or tenants, provides each tenant with its own dedicated SD-WAN edge device (e.g., edge router) to connect to the SD-WAN overlay. The dedicated edge device for the tenant is onboarded to the network, and its connections configured for the tenant. However, the techniques described herein provide for onboarding multiple tenants to a single edge device in the SD-WAN as illustrated in FIG. 1. Each tenant 110 onboard the multi-tenant edge device 108 may act as its own virtual LAN (VLAN) as illustrated. For example, tenant A is VLAN 10, tenant B is VLAN 20, etc.

The branch site 102 is connected to the data center 104 via an SD-WAN IPsec tunnel 112. The IPsec tunnel 112 allows for the virtual private networks (VPNs) that the tenants 110 may use to securely connect to network services beyond the branch site 102. For example, VPN10, VPN20, VPN30, VPN40 may be used to connect a tenant 110 to services beyond the branch site 102, specifically in environment 100, they are used to connect the tenants 110 to network services at data center 104. The data center 104 is illustrated as including networking devices such as a multi-tenant edge device 114, a layer 3 switch 116, and a multi-tenant firewall 118. However, this is by example and not limitation, data center 104 may contain any number and type of networking infrastructure.

In some instances, in example environment 100, the multiple tenants 110 hosted on the multi-tenant edge device 108 may each independently probe for network service reachability, in this example, the multi-tenant firewall 118. Note, firewall 118 is used herein as an example of a network service, and is not meant to be limiting. Any appropriate type of network service may use the techniques described here for determining the reachability of the network service. The probe results will be multiplexed on a same BFD channel towards the edge. If the probe results indicate that the network service is experiencing reachability issues, the edge device can switch traffic to other HUB sites or multi-tenant edge devices at the HUB, to handle traffic that have network service reachability in a healthy state. Additionally, since in-band processing of probes is done to obtain network reachability information, faster convergence to enable the edge device to auto switch to back up datacenters is achieved.

In certain instances, when routers at a HUB site are in graceful restart and a network service is not reachable, and routers are marked (R,S), traffic may be switched to a different HUB router when the network service is not reachable any more on a primary router. Should the controller become reachable, and devices come out of graceful restart, the original HUB will withdraw routes and advertise to the rest of the site, this does not change the forwarding path decision taken earlier via in-band probe detection, and traffic will continue to forward to the alternate HUB.

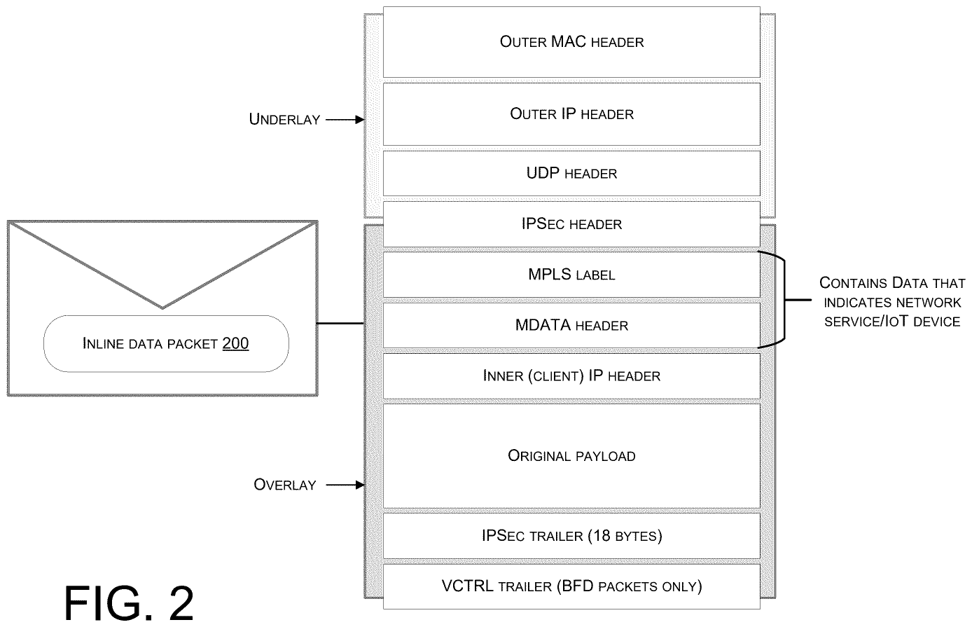

FIG. 2 illustrates an example of an inline data packet that may be utilized for relaying network service and IoT endpoint device reachability. In conventional SD-WAN infrastructure, network service and IoT endpoint device reachability, is relayed via an SD-WAN network controller. However, techniques described herein for enhanced application aware routing provide for an in-band mechanism to enable faster convergence of network failures. Inline data is used for measurements where per que level accurate measurements provide for faster detection of reachability issue in the order of seconds (e.g., 10 to 60 seconds). Additionally, in-band enhanced application aware probing provides for the ability to quickly take action to switch to a better path when a network service is not reachable for a tenant. For example, with a 10 second poll interval, if a tunnel does not meet a service level agreement (SLA) it will be taken out from SLA forwarding as quickly as 10 seconds.

FIG. 2 illustrates an example inline data packet 200. As shown, the inline data packet 200 comprises of an underlay portion and overlay portion. Additionally, the MPLS label and MDATA header contain data that indicates a network service or an IoT endpoint device that the inline data packet 200 belong to. For example, using additional metadata in this portion of the inline data packet 200, an indication of an IoT endpoint device that is offline or unreachable may be relayed to a head end network device such that remedial action may be taken. For example, a TLV may be mapped to an IoT endpoint device on the edge and embedded in the inline data packet 200, thus indicating to the head end network device which IoT device is not reachable. Again, even when the unreachable IoT device may eventually be discovered via a network controller, by relaying the information in an embedded TLV in the inline data packet 200, remediation of an IoT failure will be enabled at a significantly faster rate (e.g., in the order of seconds) than that of the network controller.

Similarly, a TLV may be mapped to a network service on the core and may be relayed via the inline data packet 200. Thus, an ability to quickly take action to switch to a better path if a network service is not reachable for a tenant in provided. Similar to IoT endpoint devices, even when network service reachability issue information may be relayed via an SD-WAN network controller, and eventually remedied, network service reachability issues may be remedied much faster using the inline mechanisms described herein. Specifically, when a network edge device receives an inline data packet 200 indicating that a network service at a datacenter is unreachable, the network edge device may switch network traffic to a second datacenter where the network service is reachable. This prevents network traffic blackholing in the time taken for an SD-WAN controller to detect that a network service is unreachable and initiate remedial action.

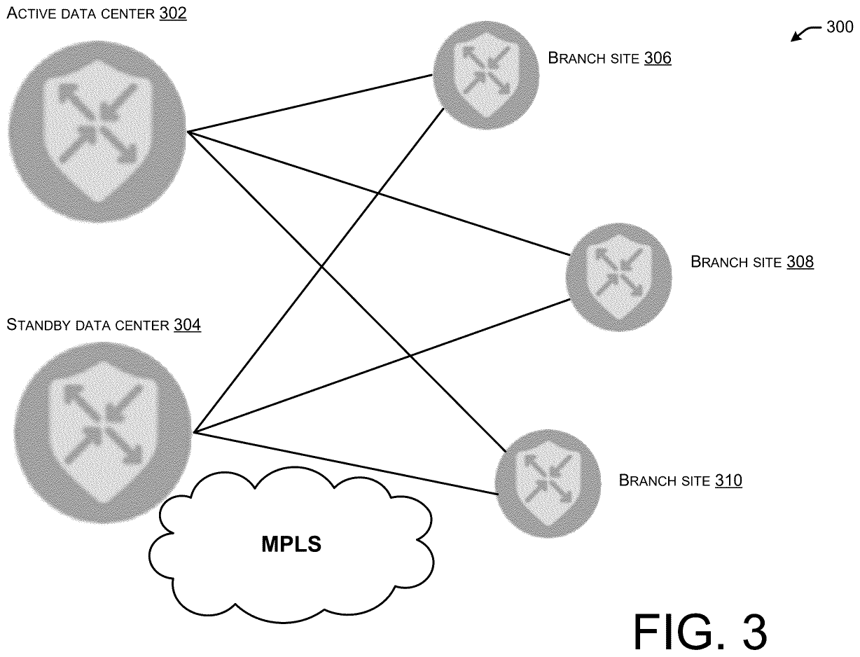

FIG. 3 illustrates an example environment 300 of a hub and spoke model that may implement techniques for detecting network service reachability. Environment 300 includes two data centers, data center 302, and data center 304. Additionally, environment 300 includes three branch sites, branch site 306, branch site 308, and branch site 310. Note, the number of datacenters and branch sites in environment 300 is exemplary and not meant to be a limitation. Any number of data centers and branch sites may implement the techniques described herein for detecting network service reachability via in-band probes. Additionally, example environment 300 is illustrated as implementing multiprotocol label switching (MPLS) for routing network traffic between the hub and spoke sites.

If a spoke site or branch site, such as branch site 306, branch site 308, or branch site 310 to a given prefix on a data center with many HUBs, the HUB preference may be to choose a HUB for geo-proximity purposes. For example, one that is physically closer. In example environment 300, each branch site is sending traffic to active data center 302 for a network service.

In some examples, some network traffic may be inspected by firewalls (e.g., see FIG. 1 for reference), or other network services as part of service chaining. Health probes sent out to the network service at active data center 302, may indicate reachability issues, in which case the network service unavailability is relayed in-band via BFD probes to a network edge device (e.g., multi-tenant edge router). The network edge device can then switch network traffic to standby data center 304 for the network service, such as firewall inspection. In conventional SD-WAN networking, such information is relayed via an SD-WAN network controller, which may lead to traffic outage for a considerable duration and result in data traffic being black holed. However, using the techniques described herein for relaying network service reachability issued via inline data packets (e.g., inline data packet 200 of FIG. 2), a network edge device may quickly switch to the standby data center 304 for a network service in a healthy state, and thus avoid blackholing new data traffic.

As an example, implementation of the techniques described herein with reference to example environment 300, a multi-tenant edge device at branch site 306 may enable a tenant onboard the multi-tenant edge device to transmit health probes (e.g., BFD probes) to a network service (e.g., a firewall) located at active data center 302. The multi-tenant edge device at branch site 306 may determine, based on the health probed, that the network service at data center 302 is unreachable. In response, the multi-tenant edge device may switch network traffic to standby data center 304 where the network service is reachable. The multi-tenant edge device may determine that the network service at data center 302 is unreachable based on a TLV associated with the network service in the BFD probe. This is in contrast to conventional methods for determining that a network service is unreachable where the information is relayed via an SD-WAN controller, which may take a significantly larger amount of time to remedy (e.g., minutes when relayed by a controller and seconds when relayed via inline packets).

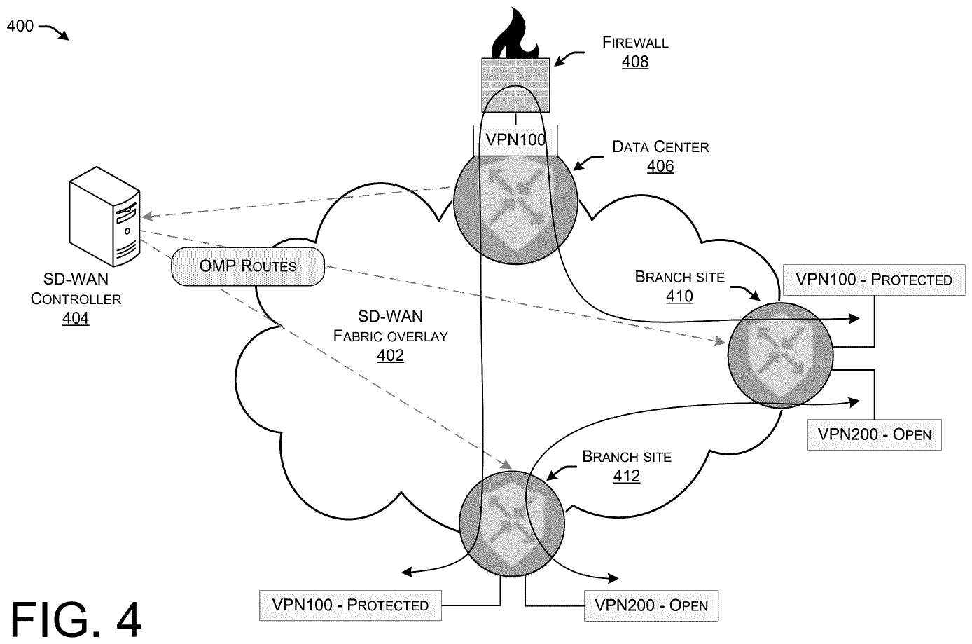

FIG. 4 illustrates an example environment 400 that may implement various aspects of the technologies directed to detecting network service reachability via inline monitoring with in-band probes in an SD-WAN overlay fabric. Example environment 400 includes and SD-WAN fabric overlay 402 and an SD-WAN controller 404. Traditionally, in an SD-WAN fabric overlay 402, any network service reachability issues will be relayed via the SD-WAN controller 404. When implementing techniques described herein, the SD-WAN network controller 404 can still detect reachability issue, although the time necessary to detect and remediate and network service reachability issues will take significantly more time that the techniques described herein, for example minutes instead of seconds.

Example environment 400 also includes a data center 406 hosting a firewall 408, a network service for inspecting network traffic. Additionally, example environment 400 includes two branch sites, branch site 410 and branch site 412. Data center 406, firewall 408, branch site 410, and branch site 412 are examples used herein for describing techniques for inline detection of network service reachability and are not meant to be limiting. More or less branch sites and data centers may be included in the infrastructure, and additional or different network services may be probed for reachability. In some examples, the branch sites may require that network traffic be inspected by firewall 408 at data center 406, as shown by protected VPN100. Health probes may be sent out to the firewall 408 from network edge device at branch site 410 and branch site 412. When reachability issues are detected based on the health probes, the network edge devices at branch site 410 and branch site 412, may switch to sending traffic requiring firewall inspection to an alternate data center (not shown) equipped with firewall inspection that is in a healthy state. Also illustrated in example environment 400, not all network traffic from branch site 410 and branch site 412 will require firewall inspection. As shown VPN200 is open and does not send traffic to data center 406 for inspection by firewall 408.

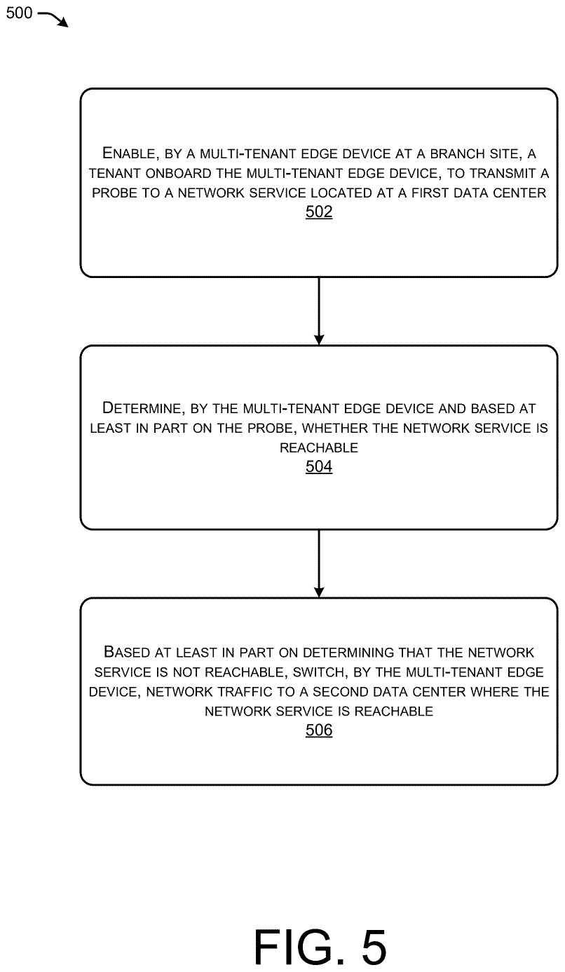

FIG. 5 is a flow diagram illustrating an example method associated with the techniques described herein for detecting network service reachability via inline monitoring with in-band probes in an SD-WAN overlay fabric. Example method 500 illustrates aspects of the functions performed by the multi-tenant edge device 108 and multi-tenant edge device 114 as described in FIG. 1. The logical operations described herein with respect to FIG. 5 may be implemented (1) as a sequence of computer-implemented acts or program modules running on a computing system and/or (2) as interconnected machine logic circuits or circuit modules within the computing system. In some examples, the method(s) 500 may be performed by a system comprising one or more processors and one or more non-transitory computer-readable media storing computer-executable instructions that, when executed by the one or more processors, cause the one or more processors to perform the method(s) 500.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in the FIG. 5 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

At operation 502, a multi-tenant edge device at a branch site enables a tenant onboard the multi-tenant edge device, to transmit a probe to a network service located at a first data center. For example, with reference to FIG. 1 the multi-tenant edge device 108 may enable one or more of the tenants 110 to probe the multi-tenant firewall 118 located at data center 104. In some examples, the probe may be a BFD probe. In some examples, different tenants onboard the multi-tenant edge device 108 may probe the firewall 118 independently, and the probe results may be multiplexed on the same BFD channel towards the edge. This will allow each tenant onboard the multi-tenant HUB router to probe at different intervals, should some tenants desire to probe more or less frequently than others. In other instances, one or more of the tenant 110 onboard the multi-tenant edge device 108 may share a probe as the probes are probing for reachability of a shared network resource, the multi-tenant firewall 118 at data center 104. In another example with reference to FIG. 3, a network edge device on branch site 306 may probe a network service located at active data center 302.

At operation 504, based at least in part on the probe, the multi-tenant edge device determines whether the network service is reachable. For example, with reference to FIG. 1 if a tenant 110 probes the multi-tenant firewall 118, the multi-tenant edge device 108 may determine, based on the probe results, whether the multi-tenant firewall 118 is reachable. In another example, with reference to FIG. 3 a network edge device at branch at branch site 306 may determine whether a network resource located at active data center 302 is reachable based on probe results. Further, referring to FIG. 2, either the multi-tenant edge device 108 of FIG. 1 of a network edge device located in branch site 306 of FIG. 3, may determine whether the network service is reachable based on information contained in the MPLS label and MDATA header that indicates a network service. For example, a TLV in a BFD probe may be mapped to the network service. Thus, the multi-tenant edge device 108 may determine the reachability of the firewall 118 via inline data packet 200 of FIG. 2.

At operation 506, based at least in part on determining that the network service is not reachable, the multi-tenant device switches network traffic to a second data center where the network service is reachable. For example, with reference to FIG. 3, if a network edge device at branch site 306 determines that a network service hosted at active data center 302 is not reachable, the network edge device at branch site 306 may switch network traffic to standby data center 304 where the network service is reachable.

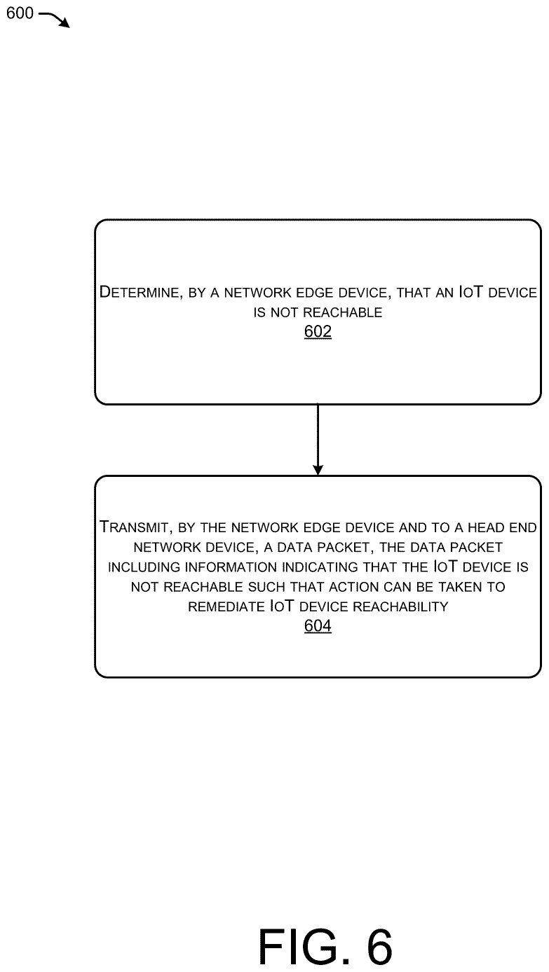

FIG. 6 is a flow diagram illustrating an example method associated with the techniques described herein for detecting IoT endpoint device reachability via inline monitoring with in-band probes in an SD-WAN overlay fabric. Example method 600 illustrates aspects of the functions performed by a network edge device such as multi-tenant edge device 108 or multi-tenant edge device 114 described with reference to FIG. 1. The logical operations described herein with respect to FIG. 6 may be implemented (1) as a sequence of computer-implemented acts or program modules running on a computing system and/or (2) as interconnected machine logic circuits or circuit modules within the computing system. In some examples, the method(s) 600 may be performed by a system comprising one or more processors and one or more non-transitory computer-readable media storing computer-executable instructions that, when executed by the one or more processors, cause the one or more processors to perform the method(s) 600.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in the FIG. 6 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

At operation 602, a network edge device determines that an IoT device is not reachable. For example, with reference to FIG. 1, branch site 102 may represent a LAN and the tenants 110 may represent multiple different IoT devices connected to the network. The access switch may be a network edge device that determines that one or more of the IoT devices are offline, have failed, or in some other way are unreachable. For instance, the access switch may detect via Zigbee, CooP, or other appropriate IoT protocol, that a particular IoT endpoint device is not reachable.

At operation 604, the network edge device transmits to a head end network device, a data packet, the data packet includes information indicating that the IoT device is not reachable such that action can be taken to remediate IoT device reachability. For example, with reference to FIG. 1, access switch 106 may transmit a data packet to head end network device that indicates with IoT device is not reachable so that action can be taken to remediate IoT device reachability. For example, with reference to FIG. 2, inline data packet 200 may be transmitted to a head end device. Data packet 200 includes a TLV mapped to the IoT device and embedded in the MPLS label and MDATA header as illustrated in FIG. 2. This enables faster convergence of network failures than traditional methods where an IoT device failure is relayed via a network controller. Note, that an IoT device failure can be relayed via both a network controller and via an inline data packet, however, the inline data packet method will be faster. For example, the inline data packet embedded with a TLV indicating the IoT device in a failure mode may be detected and remediated in a matter of seconds, where failure detection and remediate via a network controller may take a matter of minutes. In headless mode however, an IoT failure may not be detected via a network controller, however, the techniques described herein for IoT device failure detection via inline data packets will provide for IoT device failure detection in headless mode, such that action can be taken to remediate the IoT device reachability. In other words, because of the faster IoT failure detection via inline data packets, action may be taken to remediate IoT device reachability prior to IoT failure detection by an SD-WAN controller.

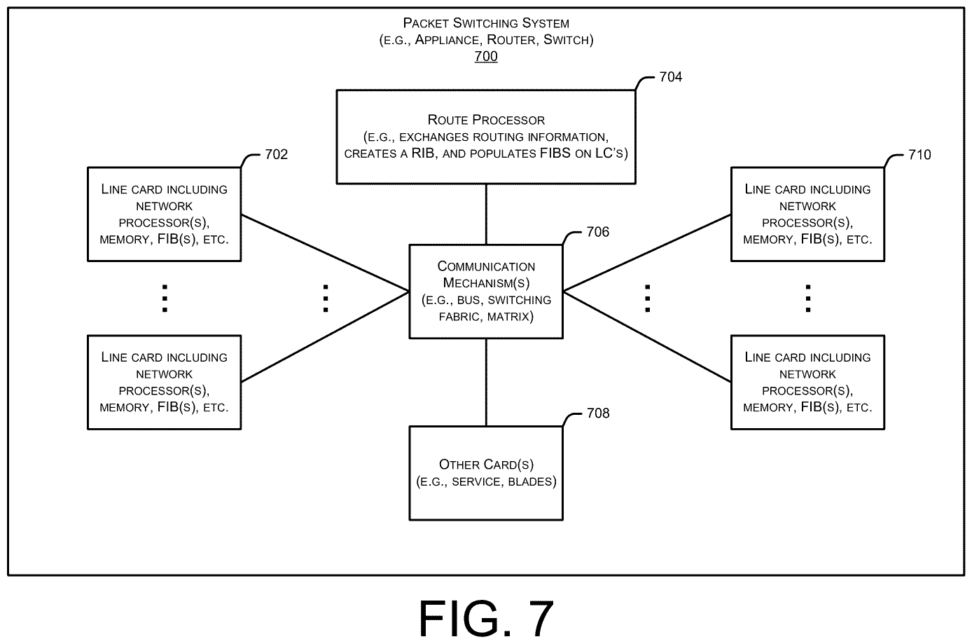

FIG. 7 illustrates a block diagram illustrating an example packet switching device (or system) 700 that can be utilized to implement various aspects of the technologies disclosed herein. In some examples, packet switching device(s) 700 may be employed in various networks, such as, for example, multi-tenant edge device 108 and multi-tenant edge device 114 described with respect to FIG. 1.

In some examples, a packet switching device 700 may comprise multiple line card(s) 702, 710, each with one or more network interfaces for sending and receiving packets over communications links (e.g., possibly part of a link aggregation group). The packet switching device 700 may also have a control plane with one or more processing elements for managing the control plane and/or control plane processing of packets associated with forwarding of packets in a network. The packet switching device 700 may also include other cards 708 (e.g., service cards, blades) which include processing elements that are used to process (e.g., forward/send, drop, manipulate, change, modify, receive, create, duplicate, apply a service) packets associated with forwarding of packets in a network. The packet switching device 700 may comprise hardware-based communication mechanism 706 (e.g., bus, switching fabric, and/or matrix, etc.) for allowing its different entities, line cards 702, 704, 708 and 710 to communicate. Line card(s) 702, 710 may typically perform the actions of being both an ingress and/or an egress line card 702, 710, in regard to multiple other particular packets and/or packet streams being received by, or sent from, packet switching device 700.

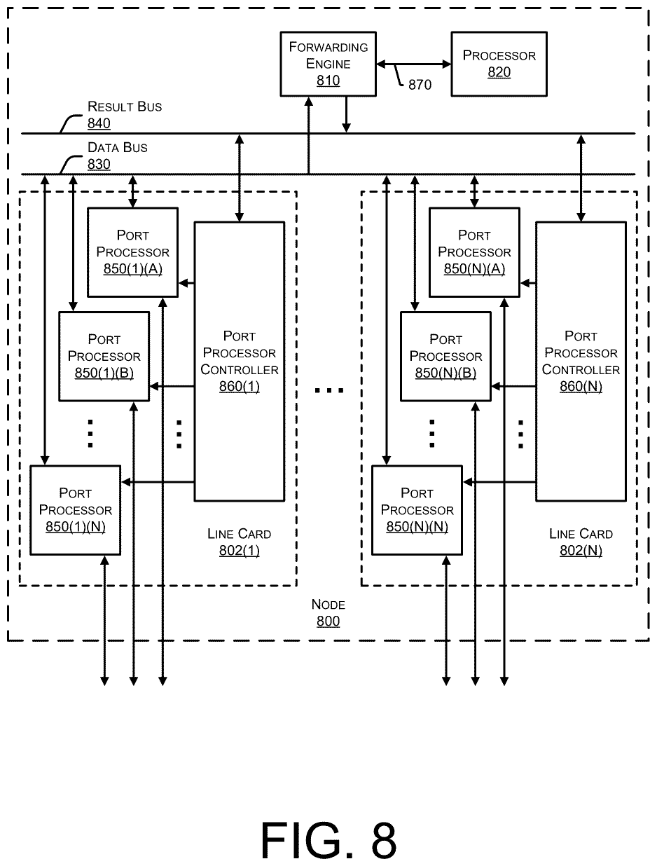

FIG. 8 illustrates a block diagram illustrating certain components of an example node 800 that can be utilized to implement various aspects of the technologies disclosed herein. In some examples, node(s) 800 may be employed in various networks, such as, for example, the SD-WAN as described with respect to FIG. 1.

In some examples, node 800 may include any number of line cards 802 (e.g., line cards 802(1)-(N), where N may be any integer greater than 1) that are communicatively coupled to a forwarding engine 810 (also referred to as a packet forwarder) and/or a processor 820 via a data bus 830 and/or a result bus 840. Line cards 802(1)-(N) may include any number of port processors 850(1)(A)-(N)(N) which are controlled by port processor controllers 860(1)-(N), where N may be any integer greater than 1. Additionally, or alternatively, forwarding engine 810 and/or processor 820 are not only coupled to one another via the data bus 830 and the result bus 840, but may also communicatively coupled to one another by a communications link 870.

The processors (e.g., the port processor(s) 850 and/or the port processor controller(s) 860) of each line card 802 may be mounted on a single printed circuit board. When a packet or packet and header are received, the packet or packet and header may be identified and analyzed by node 800 (also referred to herein as a router) in the following manner. Upon receipt, a packet (or some or all of its control information) or packet and header may be sent from one of port processor(s) 850(1)(A)-(N)(N) at which the packet or packet and header was received and to one or more of those devices coupled to the data bus 830 (e.g., others of the port processor(s) 850(1)(A)-(N)(N), the forwarding engine 810 and/or the processor 820). Handling of the packet or packet and header may be determined, for example, by the forwarding engine 810. For example, the forwarding engine 810 may determine that the packet or packet and header should be forwarded to one or more of port processors 850(1)(A)-(N)(N). This may be accomplished by indicating to corresponding one(s) of port processor controllers 860(1)-(N) that the copy of the packet or packet and header held in the given one(s) of port processor(s) 850(1)(A)-(N)(N) should be forwarded to the appropriate one of port processor(s) 850(1)(A)-(N)(N). Additionally, or alternatively, once a packet or packet and header has been identified for processing, the forwarding engine 810, the processor 820, and/or the like may be used to process the packet or packet and header in some manner and/or maty add packet security information in order to secure the packet. On a node 800 sourcing such a packet or packet and header, this processing may include, for example, encryption of some or all of the packets or packet and header's information, the addition of a digital signature, and/or some other information and/or processing capable of securing the packet or packet and header. On a node 800 receiving such a processed packet or packet and header, the corresponding process may be performed to recover or validate the packets or packet and header's information that has been secured.

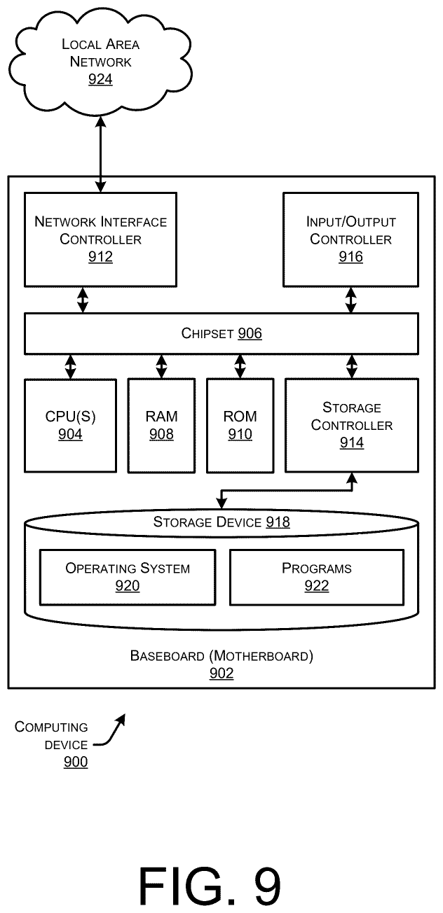

FIG. 9 shows an example computer architecture for a computing device (or network routing device) 900 capable of executing program components for implementing the functionality described above. The computer architecture shown in FIG. 9 illustrates a conventional server computer, workstation, desktop computer, laptop, tablet, network appliance, e-reader, smartphone, or other computing device, and can be utilized to execute any of the software components presented herein. The computing device 900 may, in some examples, correspond to multi-tenant edge device 108, multi-tenant edge device 114, SD-WAN controller 404, the packet switching system 700, and/or the node 800 described herein with respect to FIGS. 1, 4, 7, and 8, respectively.

The computing device 900 includes a baseboard 902, or “motherboard,” which is a printed circuit board to which a multitude of components or devices can be connected by way of a system bus or other electrical communication paths. In one illustrative configuration, one or more central processing units (“CPUs”) 904 operate in conjunction with a chipset 906. The CPUs 904 can be standard programmable processors that perform arithmetic and logical operations necessary for the operation of the computing device 900.

The CPUs 904 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 906 provides an interface between the CPUs 904 and the remainder of the components and devices on the baseboard 902. The chipset 906 can provide an interface to a RAM 908, used as the main memory in the computing device 900. The chipset 906 can further provide an interface to a computer-readable storage medium such as a read-only memory (“ROM”) 910 or non-volatile RAM (“NVRAM”) for storing basic routines that help to start up the computing device 900 and to transfer information between the various components and devices. The ROM 910 or NVRAM can also store other software components necessary for the operation of the computing device 900 in accordance with the configurations described herein.

The computing device 900 can operate in a networked environment using logical connections to remote computing devices and computer systems through a network, such as the network 924. The chipset 906 can include functionality for providing network connectivity through a NIC 912, such as a gigabit Ethernet adapter. The NIC 912 is capable of connecting the computing device 900 to other computing devices over the network 924. It should be appreciated that multiple NICs 912 can be present in the computing device 900, connecting the computer to other types of networks and remote computer systems.

The computing device 900 can be connected to a storage device 918 that provides non-volatile storage for the computing device 900. The storage device 918 can store an operating system 920, programs 922, and data, which have been described in greater detail herein. The storage device 918 can be connected to the computing device 900 through a storage controller 914 connected to the chipset 906. The storage device 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 900 can store data on the storage device 918 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 918 is characterized as primary or secondary storage, and the like.

For example, the computing device 900 can store information to the storage device 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 900 can further read information from the storage device 918 by detecting the physical states or characteristics of one or more particular locations within the physical storage units.

In addition to the mass storage device 918 described above, the computing device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device 900. In some examples, the operations performed by the multi-tenant edge devices 108 and 114, the SD-WAN controller 404, and or any components included therein, may be supported by one or more devices similar to computing device 900. Stated otherwise, some or all of the operations performed by the multi-tenant edge devices 108 and 114, the SD-WAN controller 404 and or any components included therein, may be performed by one or more computing device 900 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 918 can store an operating system 920 utilized to control the operation of the computing device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 918 can store other system or application programs and data utilized by the computing device 900.

In one embodiment, the storage device 918 or other computer-readable storage media is encoded with computer-executable instructions which, when loaded into the computing device 900, transform the computer from a general-purpose computing system into a special-purpose computer capable of implementing the embodiments described herein. These computer-executable instructions transform the computing device 900 by specifying how the CPUs 904 transition between states, as described above. According to one embodiment, the computing device 900 has access to computer-readable storage media storing computer-executable instructions which, when executed by the computing device 900, perform the various processes described above with regard to FIG. 7 and FIG. 8. The computing device 900 can also include computer-readable storage media having instructions stored thereupon for performing any of the other computer-implemented operations described herein.

The computing device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can provide output to a display, such as a computer monitor, a flat-panel display, a digital projector, a printer, or other type of output device. It will be appreciated that the computing device 900 might not include all of the components shown in FIG. 9, can include other components that are not explicitly shown in FIG. 9, or might utilize an architecture completely different than that shown in FIG. 9.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method for detecting network service reachability in an SD-WAN overlay fabric comprising:
enabling, by a multi-tenant edge device at a branch site, a tenant onboard the multi-tenant edge device, to transmit a probe to a network service located at a first data center;
determining, by the multi-tenant edge device and based at least in part on the probe, whether the network service is reachable; and
based at least in part on determining that the network service is not reachable, switching by the multi-tenant edge device, network traffic to a second data center where the network service is reachable.

2. The method of claim 1, wherein the probe is a bidirectional forwarding detection (BFD) probes.

3. The method of claim 1, wherein the tenant is a first tenant onboard the multi-tenant edge device and the probe is a first probe transmitted at a first rate, and further comprising a second tenant onboard the multi-tenant edge device that transmits a second probe at a second rate to the network service.

4. The method of claim 1, wherein the first data center is determined based at least in part on geo-proximity to the branch site.

5. The method of claim 1, wherein determining that the network service is not reachable further comprises, embedding a Type Length Value (TLV) associated with the network service in the probe.

6. The method of claim 1, wherein the network service is one of a firewall, a load balancer, or a caching infrastructure.

7. The method of claim 1, wherein the multi-tenant edge device is in headless mode.

8. A system comprising:
one or more processors; and
one or more computer-readable media storing computer-executable instructions that, when executed by the one or more processors, cause the one or more processors to perform operations comprising:
enabling, by a multi-tenant edge device at a branch site, a tenant onboard the multi-tenant edge device, to transmit a probe to a network service located at a first data center;
determining, by the multi-tenant edge device and based at least in part on the probe, whether the network service is reachable; and
based at least in part on determining that the network service is not reachable, switching by the multi-tenant edge device, network traffic to a second data center where the network service is reachable.

9. The system of claim 8, wherein the probe is a bidirectional forwarding detection (BFD) probes.

10. The system of claim 8, wherein the tenant is a first tenant onboard the multi-tenant edge device and the probe is a first probe transmitted at a first rate, and further comprising a second tenant onboard the multi-tenant edge device that transmits a second probe at a second rate to the network service.

11. The system of claim 8, wherein the first data center is determined based at least in part on geo-proximity to the branch site.

12. The system of claim 8, wherein determining that the network service is not reachable further comprises, embedding a Type Length Value (TLV) associated with the network service in the probe.

13. The system of claim 8, wherein the network service is one of a firewall, a load balancer, or a caching infrastructure.

14. The system of claim 8, wherein the multi-tenant edge device is in headless mode.

15. A method for detecting Internet of Things (IoT) device reachability comprising:
determining, by a network edge device, that an IoT device is not reachable; and
transmitting, by the network edge device and to a head end network device, a data packet, the data packet including information indicating that the IoT device is not reachable such that action can be taken to remediate IoT device reachability.

16. The method for of claim 15, wherein determining that the IoT device is not reachable further comprises using Council of Oracle Protocol (COOP) or Zigbee protocol at the network edge device to determine that the IoT device is offline.

17. The method of claim 15, wherein the information indicating that the IoT device is not reachable included in the data packet further comprises, a Type Length Value (TLV) associated with the IoT device that is not reachable, embedded in the data packet.

18. The method of claim 15, wherein the network edge device is a multi-tenant edge device with multiple IoT tenants onboard.

19. The method of claim 15, wherein the network edge device is in headless mode.

20. The method of claim 15, wherein action taken to remediate IoT device reachability is taken prior to IoT failure detection by an SD-WAN controller.
